(19) United States
(12) Patent Application Publication
(10) Pub. No.: US 2013/0093707 A1
(43) Pub. Date: Apr. 18, 2013

(54) METHOD AND APPARATUS FOR PROVIDING AN UNLOCK FUNCTION OF A TOUCH DEVICE

(71) Applicant: Samsung Electronics Co., Ltd., Gyeonggi-do (KR)

(72) Inventors: Sehwan PARK, Gyeonggi-do (KR); Youngloo Park, Gyeonggi-do (KR)

(73) Assignee: Samsung Electronics Co., Ltd., Gyeonggi-do (KR)

(21) Appl. No.: 13/650,640

(22) Filed: Oct. 12, 2012

(30) Foreign Application Priority Data
Oct. 12, 2011 (KR) 10-2011-0104250

(51) Int. Cl. G06F 3/041

(52) U.S. Cl. 345/173

(57) ABSTRACT

A method and apparatus for providing an unlocking function of a touch device are provided. The method includes receiving an unlock interaction input for releasing of a locking mode of the touch device; displaying a preview of an execution screen of an application to be executed while releasing the locking mode; and completely displaying the execution screen, when the locking mode is completely released by a completion of the unlock interaction input.

### PRIORITY

This application claims priority under 35 U.S.C. §119(a) to Korean Patent Application Serial No. 10-2011-0104250, which was filed on Oct. 12, 2011 in the Korean Intellectual Property Office, the entire disclosure of which is hereby incorporated by reference.

### BACKGROUND OF THE INVENTION

1. Field of the Invention

The present invention relates generally to a method and apparatus for controlling a touch device supporting a touch-based input, and more particularly, to a method and apparatus for providing an unlock function of a touch device that supports a lock mode cancelation and supports prompt execution of an application according to user selection at the time of the lock mode cancelation.

2. Description of the Related Art

In order to prevent inadvertent or unauthorized entries being input though a touch screen of a device including the touch screen, i.e., a touch device, a touch device often includes a locking function, which displays a locking User Interface (UI) that prevents input though the touch screen during a standby state, except for inputs used to release the locking function, i.e., unlock the touch device. For example, a preset password or pattern may be entered or a separate locking mode release key, e.g., a sliding lock release function, may be input to unlock the touch device.

However, these types of methods are often inconvenient for a user who wants to quickly unlock their touch device.

Further, after unlocking the touch device, the locking UI is replaced with a screen that was last viewed by the user, prior to the touch device being locked. However, when the user unlocks the touch device in front of another person, the last viewed screen is made public, which causes a privacy problem.

### SUMMARY OF THE INVENTION

The present invention has been made in view of at least the above-described problems, and provides at least the advantages described below.

Accordingly, an aspect of the present invention is to provide a method and apparatus for providing an unlocking function of a touch device.

Another aspect of the present invention is to provide a method and apparatus for providing an unlocking function of a touch device that directly executes a desired application at the time of releasing the locking mode.

Another aspect of the present invention is to provide a method and apparatus for providing an unlocking function of a touch device based on a user's privacy at the time of releasing the locking mode.

In accordance with an aspect of the present invention, a method for providing a locking function of a touch device is provided. The method includes receiving an unlock interaction input for releasing of a locking mode of the touch device; displaying a preview of an execution screen of an application to be executed while releasing the locking mode; and completely displaying the execution screen, when the locking mode is completely released by a completion of the unlock interaction input.

In accordance with another aspect of the present invention, a method for providing a locking function of a touch device is provided. The method includes displaying a lock user interface according to user's setting or a randomly selected lock user interface among a plurality of lock user interfaces, wherein the lock user interface includes a zipper-type lock user interface, a knot-type lock user interface, and a non-knot-type lock user interface.

In accordance with another embodiment of the present invention, a computer readable recording medium recording a program to be executed by a processor is provided for implementing the above methods.

In accordance with another aspect of the present invention, a touch device is provided, which includes a touch sensor that receives an unlock interaction input during a locking mode; a display that displays a locking User Interface (UI); and a controller that determines whether the locking mode is released based on the unlock interaction input received through the locking UI, and displays an execution screen of an application via the display, when the unlock interaction input is completed.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following detailed description in conjunction with the accompanying drawings, in which:

FIG. 1 illustrates a touch device according to an embodiment of the present invention;

FIGS. 2 to 4 illustrate various lock user interfaces that are supported in a touch device according to an embodiment of the present invention;

FIGS. 5 and 6 illustrate a method of releasing a locking mode using a locking UI according to an embodiment of the present invention;

FIGS. 7 and 8 illustrate a method of releasing a locking mode using a locking UI according to an embodiment of the present invention; and

FIG. 9 is a flowchart illustrating a method of unlocking a touch device according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

A configuration of a touch device and a method for controlling an operation of the touch device is described with reference to accompanying drawings. However, because a configuration of a touch device and a method of controlling an operation thereof according to an embodiment is not limited to following contents, it will be noticed that they are applicable to various embodiments based on the following description.

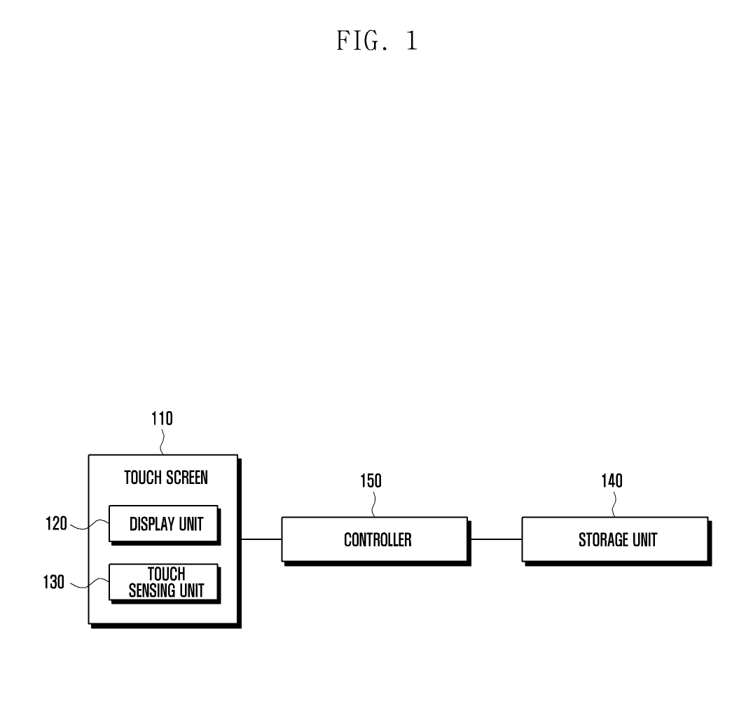

FIG. 1 illustrates a touch device according to an embodiment of the present invention.

Referring to FIG. 1, the touch device includes a touch screen 110, a storage unit 140, and a controller 150. The touch device may further include additional units not shown, such as an audio processor having a microphone and a speaker; a digital broadcasting module for receiving digital broadcasting (e.g., mobile broadcasting such as Digital Multimedia Broadcasting (DMB) or Digital Video Broadcasting (DVB)); a camera module for photographing a still image and a moving image of a subject; at least one near distance communication module for supporting a near distance wireless communication based function such as Radio Frequency Identification (RFID) communication or Near Field Communication (NFC); an input unit for supporting input based on a hard key; an RF module for supporting a communication function such as mobile communication based voice call, moving call, and data call; a communication module for supporting Internet Protocol (IP) based Internet communication service; and a battery for supplying power to the foregoing structural elements. For example, the touch device may be a mobile communication terminal, a tablet Personal Computer (PC), a smart phone, a digital camera, a Portable Multimedia Player (PMP), a media player, a portable game terminal, a laptop computer, a Personal Digital Assistant (PDA), a digital television, Digital Signage (DS), a Large Format Display (LFD), etc.

The touch screen 110 is an input and output (display) device, and includes a display unit 120, such as a Liquid Crystal Display (LCD), a Light Emitting Diode (LED), an Organic LED (OLED), and an Active Matrix OLED (AMOLED), etc., and a touch sensing unit 130.

When the touch screen 110 displays a locking UI through the display unit 120 and an unlocking input is received through the touch sensing unit 130, the unlocking input is transmitted to the controller 150, which executes a lock mode release and application in response to the unlocking input and outputs an execution screen of the application through the display unit 120.

The display unit 120 displays screens related with the operation state of the touch device. For example, the display unit 120 displays a lock screen of a touch device, a home screen, a menu screen, and execution screens according to the various applications. The display unit 120 can be turned on or off according to the control of the controller 150 at the standby state.

The display unit 120 displays the locking screen including the locking UI. For example, the locking UI may include an unlocking object for user selection.

Further, the display unit 120 may display a preview execution screen of an application, which will be executed when the locking mode is released using the locking UI. A screen configuration of the display unit 120 and a screen example thereof will be described later. Further, when displaying an execution screen as above, the display unit 120 may support a screen display by horizontal mode, a screen display by vertical mode and an adaptive screen conversion display according to a change between horizontal mode and vertical mode according to the rotational direction (or disposed direction) of the touch device.

The touch sensing unit 130 is disposed on the display unit 120, and senses user inputs (e.g., a touch interface, a tab interaction, and a drag interaction, etc.) when the user contacts the surface of the touch screen 110. When sensing the user input on the surface of the touch screen 110, the touch sensing unit 130 detects the coordinates where the input was received, and transmits the detected coordinates to the controller 150. That is, the touch sensing unit 130 senses the interaction input generated by user, and generates a signal according to the sensed interaction and transmits the generated signal to the controller 150.

Thereafter, the controller 150 performs a function corresponding to the signal transmitted in the touch sensing unit 130. For example, the touch sensing unit 130 may receive an unlocking input to release the locking mode of the touch device through the locking UI.

The storage unit 140 stores various applications and data which is executed and processed in the touch device, and includes a nonvolatile memory and/or a volatile memory. For example, the storage unit 140 may include a Read Only Memory (ROM), a flash memory, a Random Access Memory (RAM), an internal Hard Disk Drive (HDD), an external hard disk drive, and an external storage medium, etc. The storage unit 140 can continually or temporarily store the operating system of the touch device, a program and data related with input and display control operation using the touch screen 110, and a program and data related with the operation of the locking mode release function of the touch device, etc. In particular, the storage unit 140 stores a locking UI to be provided as the lock screen, an unlock object for each locking UI, and mapping information of applications to be executed by the unlock object of the locking UI.

The controller 150 controls the general operation of the touch device, and therefore, senses an unlocking input transmitted by the touch screen 110 in the lock mode and controls the unlocking of the touch device and the execution of a particular application in response to the unlocking input.

In particular, the controller 150 control a locking UI according to a user setting or displays a randomly selected locking UI from among a plurality of locking UIs. Further, the controller 150 determines whether the lock mode is released according to an unlocking input received in the locking UI, and controls the display of an application execution screen according to the unlocking input.

Specifically, when an unlocking input is received in the locking UI, the controller 150 may display a preview for an application which will be executed during the release of the locking mode according to the unlock interaction. Further, the controller 150 then displays an execution screen of the application when the locking mode is released by the unlocking input. Likewise, the controller 150 can control general operation for the function operation of the present invention, and the detailed control operation of the controller 150 will be explained later in the operation example of the touch device and the control method thereof with reference to drawings.

Further, the controller 150 can control various operations related with a general function of the touch device in addition to the above function. For example, when a certain application is executed, the controller 150 can control the operation of the execution and the screen display. Further, the controller 150 can receive an input signal corresponding to various touch event inputs supported in the touch-based input interface, and control function operation according thereto. Further, the controller 150 can control transmission and reception of various data based on a wired communication or wireless communication.

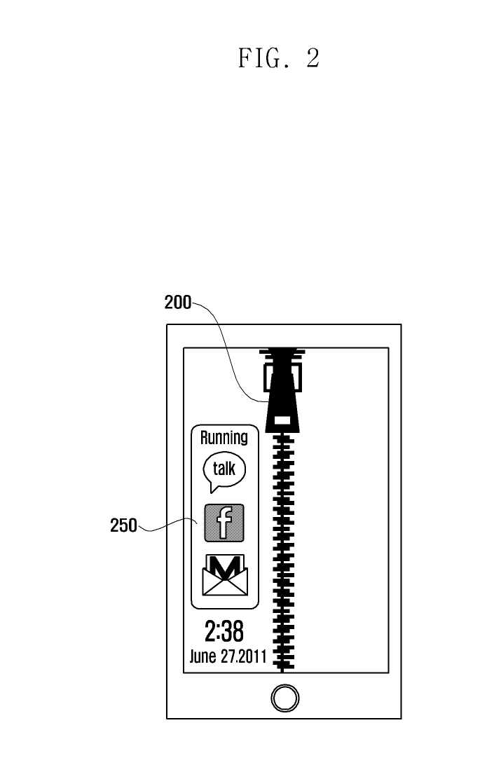

FIGS. 2 to 4 illustrate various locking UIs that are supported in a touch device according to an embodiment of the present invention.

As illustrated in FIGS. 2 to 4, a lock screen includes a locking UI is provided. For example, a locking UI includes an intuitive UI, which uses a medium in daily lives, such as a zipper type, a knot type having a connection between holes (e.g., a shoelace knot type, etc.), a non knot type that does not have a connection between holes (e.g., a shoe type without a lace), etc. A specific locking UI may be provided or a random locking UI from among a number of locking UIs may be provided according to a user setting in a device.

Referring to FIGS. 2 to 4, the locking UIs include unlock items 200, 300, and 400, through which an unlock interaction for releasing the locking mode is input. Basically, the unlock items 200, 300 and 400 correspond to the starting point where an unlock interaction for the release of the locking mode is input.

Further, referring to FIG. 2, the locking UI includes an application item 250, which indicates application information for an application which will be entered when the locking mode is released using the unlock items 200, 300, and 400.

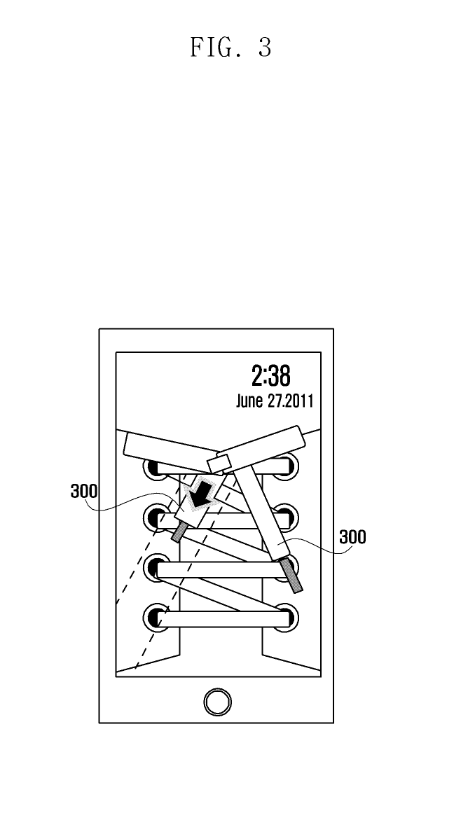

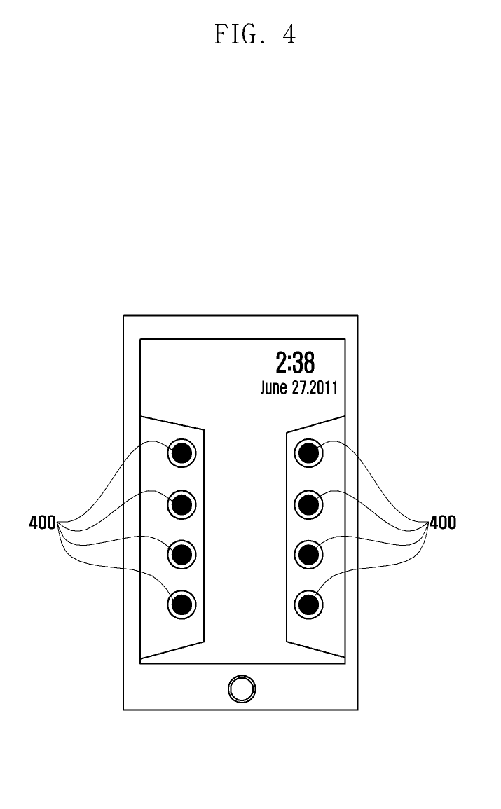

The unlock items 200, 300, and 400 can correspond to a slide handle of a zipper in a zipper-type lock user interface as shown in FIG. 2, the end part 300 of the knot in the knot-type lock user interface as shown in FIG. 3, and a hole 400 in the non-knot-type lock user interface as shown in FIG. 4. Such unlock items 200, 300 and 400 can correspond to the starting point where an unlock attraction for the release of the locking mode is inputted. The unlock interaction input using each unlock item 200, 300, and 400 and the locking mode release operation according thereto will be explained later with reference to drawings.

Further, in FIGS. 2 to 4, the application item 250 is for representing application information for the application which is expected to be promptly entered along with the locking mode at the time of inputting the unlock interaction based on the unlock items 200, 300, and 400 as the above. The application item 250 may be selectively displayed or the display may be omitted according to a user setting in a device. Additionally, the application item 250 may include an image, text, or a combination thereof, which identifies the applications.

For example, in the case of a locking UI as illustrated in FIG. 2, the application item 250 for at least one application can be provided in one are of the locking UI. FIG. 2 identifies three applications (i.e., a talk application, a social networking application, and a messaging application) on the left area of the locking UI. However, the number of applications indicated by the application item 250 and the positioning of the application item 250 may vary.

Further, the application item 250 may include an application according to a user setting or an application, which was previously executed and managed. That is, applications included in the application item 250 may include a default application, an application last used, an application running when the device enters the locked mode, etc. For example, if there is no application currently being executed, the area may be provided as a blank space, an application item for the currently used application is provided as many as the preset number, or information on the initial menu screen may be displayed, which can be defined according to user's setting.

In FIG. 3, although not illustrated, an application item can be provided. For example, an application item may be provided through each unlock item 300 (e.g., the end part for releasing a knot).

In FIG. 4, although not illustrated, an application item can be provided. For example, an application item may be provided through the surrounding area (e.g., the bottom of a hole) of the unlock item 400 (e.g., each hole).

According to the above-described embodiments of the present invention, various intuitive locking UIs for supporting the lock mode release function can be provided. Further, a user can intuitively recognize an unlock interaction for releasing the locking mode for the given locking UI, and identify which application will be executed upon unlocking the device.

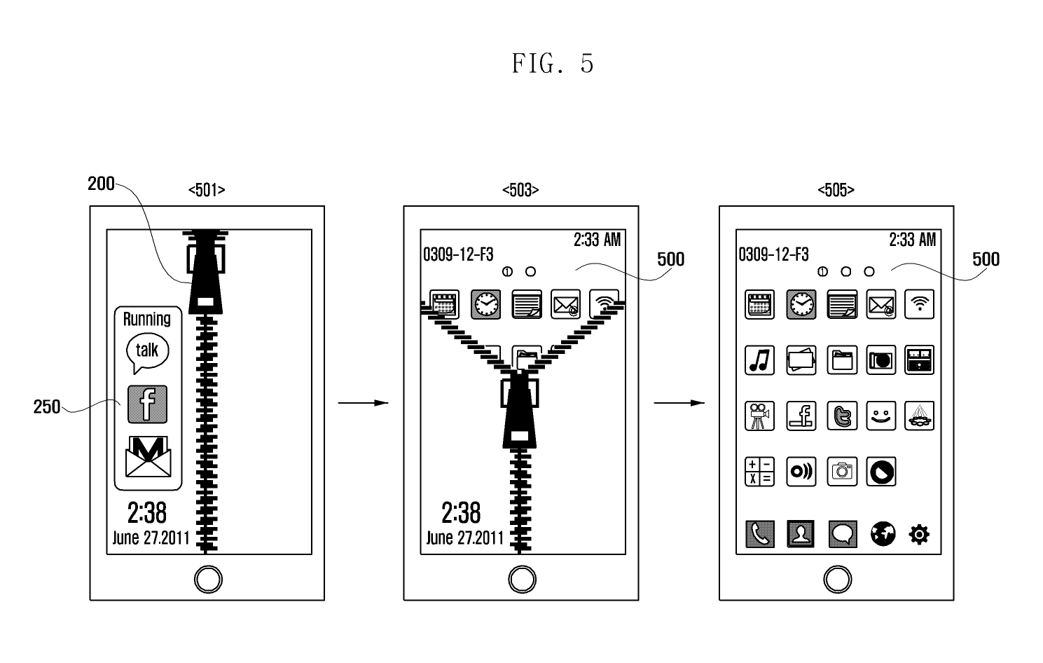

FIG. 5 illustrates a method for releasing a locking mode using a locking UI according to an embodiment of the present invention. Specifically, FIG. 5 illustrates a zipper-type locking UI and a screen example of a case where the locking UI includes the application item 250. At this time, FIG. 5 illustrates an example of a case, where a user releases the locking mode using only the unlock item 200 without using the application item 250.

Referring to FIG. 5, as illustrated in screen 501, a locking screen including the zipper-type locking UI is displayed. The locking UI includes an unlock item 200 and an application item 250, as described above.

In screen 501, the user selects the unlock item 200 (i.e., a slide handle image of a zipper), and inputs an unlock interaction which moves the unlock item 200 downward. Then the touch device can sense the unlock interaction based on the unlock item 200, and check the previously executed application. Here, the previously executed application can include the initial home screen.

Further, in screen 503, the user is presented with an execution screen 500 (part of the home screen) as the user enters the unlocking interaction, i.e., moves the unlock item 200 downward. The changed locking UI indicates a UI of a type that the internal screen (e.g., a preview execution screen) gradually appears as the zipper is opened in response to the movement of the unlock item 200 according to the unlock interface as illustrated in reference numeral 503. Further, the execution screen 500 corresponds to the preview execution screen of an application provided in the form of a preview so that user can recognize the execution screen to be provided according to the release of the locking mode in advance, and can be constituted at the bottom in a layer which is different from the locking UI. Through such a preview execution screen, user can recognize the execution screen to be opened to the public at the time of releasing the locking mode in advance. Further, according to the present invention, while the unlock interaction is inputted, an input according to the preview execution screen does not occur, and only an input according to the unlock item 200 can be sensed by the touch sensing unit 130.

Accordingly, as the execution screen 500 is gradually displayed to the user, the user may preview the screen that is going to be displayed, thereby allowing the user to stop unlocking the device, if the user does not wish to display the execution screen 500 to another person that is also viewing the device. For example, as shown in reference number 503, in the state where the unlock interaction based on the unlock item 200 is inputted, user may desire not to open to the public the execution screen corresponding to the preview execution screen for privacy, or desire a preview by another application or execution by another application at the time of the locking mode release. In such a case, the user may stop the unlock interaction, such that the device then displays the initial locking UI as illustrated in screen 501. That is, the device then displays the initial locking UI as illustrated in screen 501 when sensing the release of the unlock interaction before the locking mode is completely released according to the unlock interaction (i.e., before the unlock condition for releasing the locking mode is satisfied). For example, in the device, screen 503 may directly return to screen 501, or the unlock item 200 may move upward, such that the zipper gradually closes until screen 501 is provided.

Alternatively, the use may partially unzip the unlock item 200, and select one of the icons on the partially displayed execution screen 500.

When the user moves the unlock item 200 to the bottom of the screen to release the locking mode. That is, the unlock interaction can be inputted up to the unlock condition for the release of the locking mode (in FIG. 5, this may correspond to the case where the unlock item 300 is positioned at the bottom of the zipper image). The device recognizes the locking mode release, and completely displays the execution screen 500 (e.g., a home screen), as illustrated in screen 505.

Although FIG. 5 illustrates a home screen as the execution screen 500, the execution screen 500 may be a default application, an application last used, an application running when the device enters the locked mode, etc.

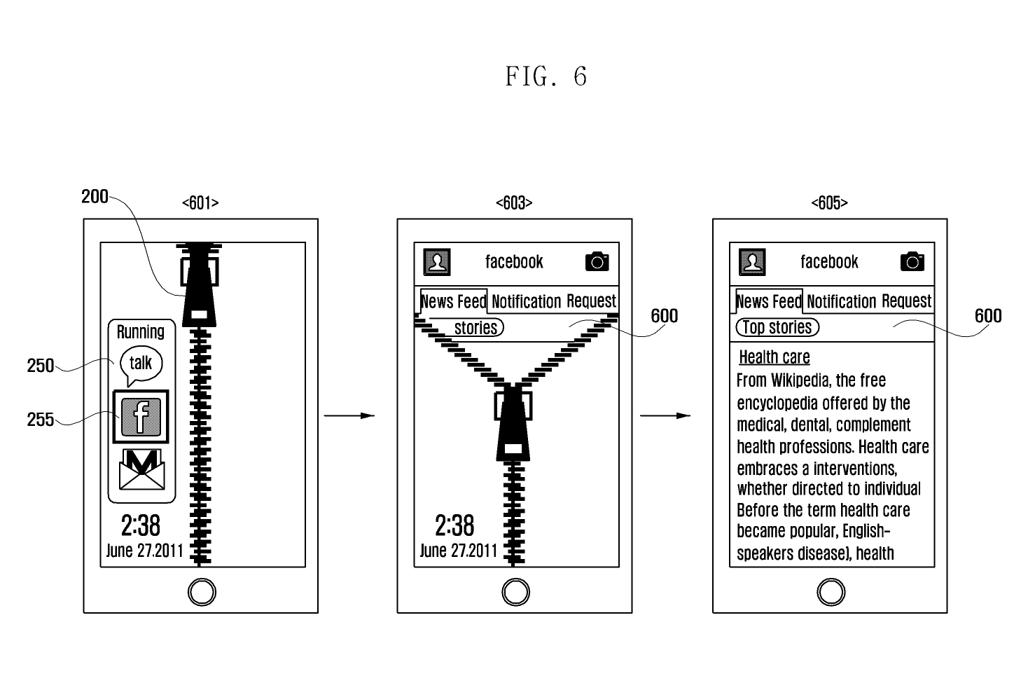

FIG. 6 illustrates a method for releasing a locking mode using a locking UI according to an embodiment of the present invention. Specifically, FIG. 6 illustrates a zipper-type locking UI including an application item 250, where the locking mode is released using both the application item 250 and an unlock item 200.

Referring to FIG. 6, in screen 601, the locking UI includes the unlock item 200 and the application item 250, as described above.

In screen 601, the application item 250 indicate the applications that are currently running in the device, which can be immediately executed upon unlocking the device. For example, when the user selects (i.e., the status that user input for an application item selection is maintained, or the status that select the application item, and the user input is released) the social network application 255 from the application item 250 and then inputs an unlock interaction which moves the unlock item 200 downward, the device senses the unlocking interaction based on the application 255 and the unlock item 200, and identifies the corresponding application 255.

Further, in screen 603, the device starts revealing an execution screen 600 for the application 255 as the user enters the unlock interaction.

As described above, in FIG. 5, the user may stop the unlock interaction, such that the device then displays the initial locking UI as illustrated in screen 601. For example, in the device, screen 603 may directly return to screen 601, or the unlock item 200 may move upward, such that the zipper gradually closes until screen 601 is provided.

When the user moves the unlock item 200 to the bottom of the screen to release the locking mode, the device recognizes the locking mode release, and completely displays the execution screen 600 (i.e., a screen of the social networking application), as illustrated in screen 605.

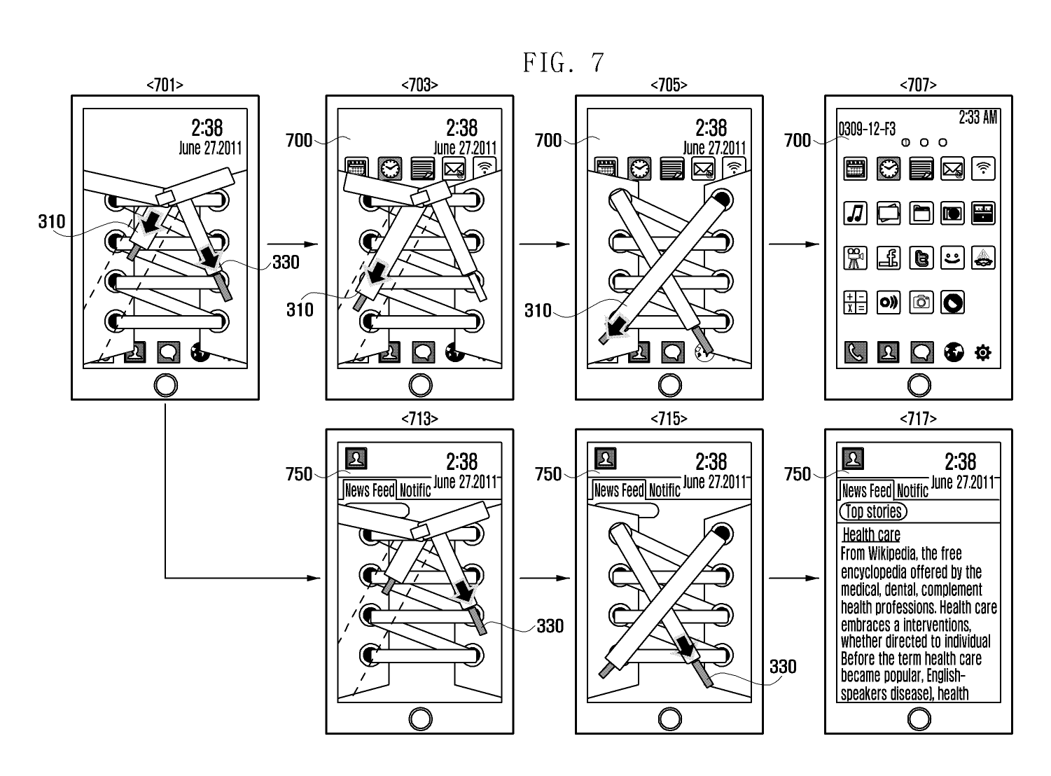

FIG. 7 illustrates a method for releasing a locking mode using a locking UI according to an embodiment of the present invention. Specifically, FIG. 7 illustrates a knot-type locking UI, which includes two unlock items 310 and 330.

Referring to FIG. 7, in screen 701, it is assumed that the lock screen including the knot type locking UI of the present invention is displayed. At this time, the locking UI includes an unlock item 300 as considered above, and it is assumed that the unlock item 300 is divided into two unlock items 310 and 330. Different applications are associated with each of the two unlock items 310 and 330, e.g., are registered according a user setting. Further, although not illustrated in FIG. 7, application information for each application can be provided for each unlock item 310 and 330 by an image, a text or a combination thereof according to user's setting. Therefore, a user can enter the execution screen of an application when releasing the locking mode according to the unlock interaction using the selected unlock item.

For example, in screen 701, a user can input an unlock interaction which moves in a certain direction (e.g., a downward direction, a direction that is diagonal downward but is curved in the middle for the space utilization like “<” shape), and a zigzag direction, etc.) to release the knot by selecting an unlock item 310 (e.g., the end of the left knot). The device then senses the unlock interaction based on the unlock item 310, and indentifies a corresponding application.

Further, in screen 703 and 705, as the unlock item 310 is moved, the locking UI changes according to the unlock interaction. At this time, the touch device can be indicated by combining the execution screen 700 (e.g., part of the home screen) for the identified application and the locking UI changes according to the unlock interaction. Specifically, the changed locking UI illustrates the knot being gradually released in response to the movement of the unlock item 310. Further, as the knot is gradually released in response to the movement of the unlock item 310, an execution screen 700 is gradually displayed to the user, allowing the user to preview the display in screen 703. For example, the execution screen 700 corresponds to a preview execution screen of an application provided in the form of a preview so that user can recognize the execution screen to be provided according to the release of the locking mode in advance, and can be constituted at the bottom with a layer which is different from the locking UI. Further, an input bay the preview execution screen does not occur while the unlock interaction is inputted, and only an input by the unlock item 310 can be sensed by the touch sensing unit 130.

Again, this preview function allows the user to stop unlocking the device, if the user does not wish to display the execution screen 700 to another person that is also viewing the device. In such a case, the user may stop the unlock interaction, such that the device then displays the initial locking UI as illustrated in screen 701. For example, in the device, screen 703 may directly return to screen 701, or the unlock item 310 may move upward, such that the knot reties until screen 701 is provided.

In screen 705, the user moves the unlock item 310 to the bottom of the screen (or the position where the knot is completely released) so as to release the locking mode, thereby releasing the locking mode. The touch device senses the locking mode release by the unlock interaction, and displays the execution screen 700 (e.g., a home screen) as illustrated in reference numeral 707.

Further, in screen 701, when user inputs an unlock interaction that moves the unlock item 330, as illustrated in screen 713 and 715, the touch device senses the application correspond to the unlock item 330, i.e., the social networking application, and gradually displays an execution screen 750 corresponding to the social networking application.

In screen 715, the user moves the unlock item 330 to the bottom of the screen (or the position where the knot is completely released), thereby releasing the locking mode. The touch device senses the locking mode release by the unlock interaction, and displays the execution screen 750 (i.e., a screen of the social networking application), as illustrated in reference numeral 717.

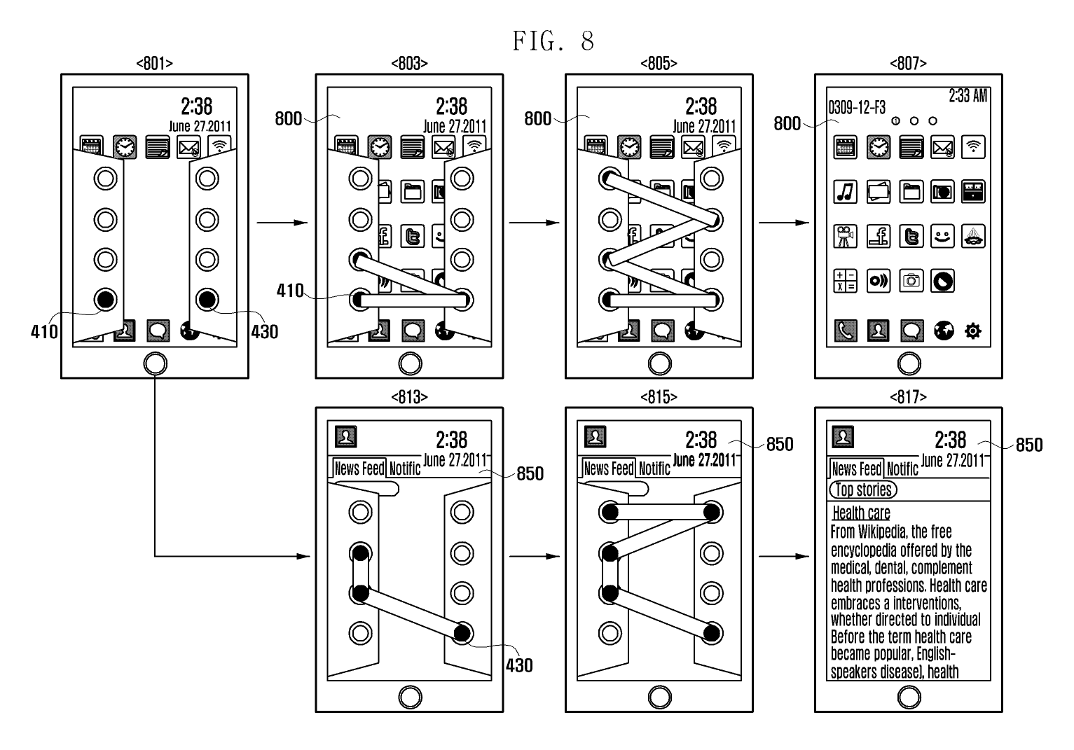

FIG. 8 illustrates a method for releasing a locking mode using a locking UI according to an embodiment of the present invention. Specifically, FIG. 8 illustrates a non-knot type locking UI, i.e., a shoe without laces, which includes a plurality of unlock items.

Referring to FIG. 8, in screen 801, each of the holes can be designated as an unlock item, such that there are 8 unlock items. Further, different applications may be associated for each unlock item. Additionally, although not illustrated in FIG. 8, application information for each application can be provided near each unlock item using an image, text, or a combination thereof Hence, a user can enter an execution screen of an application when the locking mode is released according to the unlock interaction using the selected unlock item.

For example, in screen 801, the user selects an unlock item 410 (e.g., a hole at the left bottom) where an execution-desired application has been registered, and inputs an unlock interaction which moves in an arbitrary direction (e.g., a zigzag direction, etc.) for tying a knot. The touch device senses an unlock interaction based on the unlock item 410, and identifies the application corresponding to the unlock item 410.

Further, in screen 803 and 805, the device displays a preview of an execution screen 800 (e.g., part of a home screen) for the identified application, and a changing locking user interface based on the UI. The changed locking UI represents a knot being gradually tied in response to the movement of the unlock item 410 according to the unlock interaction.

Again, this preview function allows the user to stop unlocking the device, if the user does not wish to display the execution screen 800 to another person that is also viewing the device. In such a case, the user may stop the unlock interaction, such that the device then displays the initial locking UI as illustrated in screen 801. For example, in the device, screen 803 may directly return to screen 801, or the knot gradually unties until screen 801 is provided.

In screen 805, the user moves the lace to the top of the screen (or the position where the knot is completely tied), thereby releasing the locking mode. The touch device senses the locking mode release by the unlock interaction, and displays the execution screen 800 (e.g., a home screen) as illustrated in reference numeral 807.

Further, in screen 801, when user inputs an unlock interaction that moves the unlock item 430, as illustrated in screen 813 and 815, the touch device senses the application correspond to the unlock item 430, i.e., the social networking application, and gradually displays an execution screen 850 corresponding to the social networking application.

In screen 815, the user moves the unlock item 430 to the top of the screen (or the position where the knot is completely tied), thereby releasing the locking mode. The touch device senses the locking mode release by the unlock interaction, and displays the execution screen 850 (i.e., a screen of the social networking application), as illustrated in reference numeral 817.

Although FIG. 8 illustrates releasing the locking mode based on unlock item selected, alternatively, the locking mode may be released based on patterns of tying the knot and executing an application according to the pattern of the locking mode release. Therefore, it is possible to release the locking mode when responding to the pattern where the pattern in which the unlock interaction is inputted has been set, and to provide the execution screen by executing an application registered in the pattern at the time of releasing the locking mode.

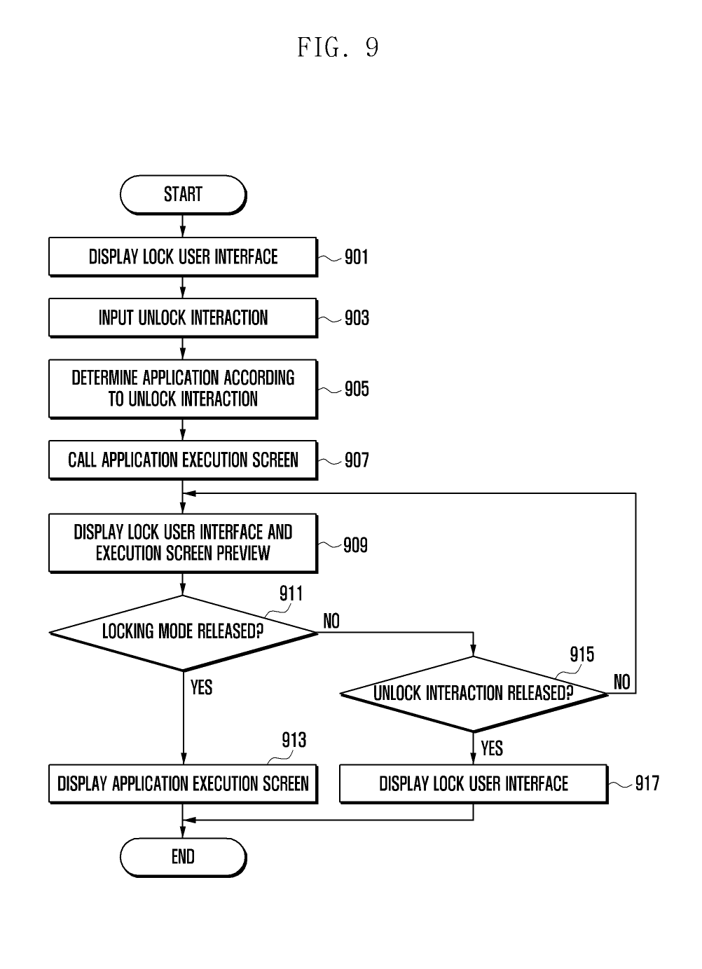

FIG. 9 is a flowchart illustrating a method of unlocking a touch device according to an embodiment of the present invention.

Referring to FIG. 9, in step 901, the touch device displays a locking UI, e.g., in response to a user request. As described above, examples of the locking UI include a zipper-type locking UI, a knot-type locking UI, a non-knot-type locking UI, etc.

In step 903, the touch device senses an unlock interaction input.

In step 905, the touch device determines an application according to the unlock interaction. For example, as described above, user can input an unlock interaction in a manner that responds to the given lock user interface. For example, an unlock interaction based on an unlock item may be inputted, or an unlock item based on an application item and an unlock item may be inputted. Then the controller 150 can determine the type of an unlock interaction (e.g., the above former type or the latter type) inputted in the given lock user interface, and determine the application mapped to the unlock item or the application item selected according to the determined unlock interaction type.

In step 907, the touch device calls an application execution screen corresponding to the determined application.

In step 909, the touch device partially displays the execution screen in the locking UI as a preview. As described above, the touch device gradually displays the execution screen while changing the displayed locking UI according to the unlock interaction being received by the user.

In step 911, the touch device determines whether the locking mode is released. For example, the touch device determines whether the unlock interaction has been inputted until an unlock condition for releasing the locking mode is completely satisfied. That is, the controller 150 can determine that the locking mode is released when the unlock interaction is inputted in a manner that satisfies the unlock conditions.

When the touch device determines that the locking mode is released (YES in step 911), the locking mode is released, and the execution screen of the application is displayed in step 913.

However, when the touch device determines that the locking mode is not released (NO in step 911), the touch device determines whether the unlock interaction is released in step 915.

When the unlock interaction is not released (NO in step 915), the touch device continues to display the preview screen in step 909. However, when the unlock interaction is released (YES in step 915), the touch device displays the initial lock user interface in step 917.

The above-described methods for providing an unlocking function in a touch device of the present invention may be implemented in an executable program command form by various computers and be recorded in a non-transitory computer readable recording medium. In this case, the computer readable recording medium may include a program command, a data file, and a data structure individually or a combination thereof The program command recorded in a recording medium may be specially designed or configured for the present invention or be known to a person having ordinary skill in a computer software field to be used.

The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as a floptical disk, and a hardware device such as a ROM, RAM, or flash memory for storing, and executing program commands. Further, a program command includes a machine language code created by a complier and a high-level language code executable by a computer using an interpreter. The foregoing hardware device may be configured to be operated as at least one software module to perform an operation of the present invention, and vice versa.

As described above, in methods and apparatuses for providing an unlocking function of a touch device according to embodiments the present invention, when releasing a locking mode of a touch-based touch device, intuitiveness and convenience can be provided. Further, when unlocking state the touch device, a quick entrance to an execution screen of a certain application corresponding can be provided, enhancing user convenience.

According to the present invention, user can more intuitively and conveniently perform a unlocking function by supporting an intuitive user interface for releasing the locking mode. Further, when releasing the locking mode through the unlock interaction in the given user interface, whether the locking mode needs to be released can be determined in consideration of user privacy by checking the screen to be executed according to the release of the locking mode. Further, when user releases the locking mode, a quick confirmation and entrance to the execution screen of an application user desires to execute can be supported through a preview screen according to the release of the locking mode.

The present invention can be implemented in all types of touch devices and other various devices corresponding thereto. Further, according to the present invention, an optimal environment is implemented for a locking mode release in a touch device and a prompt execution of an application according to the release of the locking mode, and thus the present invention can contribute to improvement of usability, convenience and competitiveness of a touch screen.

Although certain embodiments of the present invention have been described in detail hereinabove, it should be clearly understood that many variations and modifications of the basic inventive concepts taught herein, which may appear to those skilled in the present art, will still fall within the spirit and scope of the present invention, as defined in the appended claims and their equivalents.

What is claimed is:

1. A method for providing an unlocking function of a touch device, the method comprising:
receiving an unlock interaction input for releasing of a locking mode of the touch device;
displaying a preview of an execution screen of an application to be executed while releasing the locking mode; and
completely displaying the execution screen, when the locking mode is completely released by a completion of the unlock interaction input.

2. The method of claim 1, further comprising:
displaying a locking User Interface (UI).

3. The method of claim 2, wherein the locking UI includes an unlock item through which the unlock interaction is input.

4. The method of claim 3, wherein the locking UI includes an application item for the application that is executed when the locking mode is released.

5. The method of claim 4, wherein the locking UI includes one of a zipper-type locking UI, a knot-type locking UI, and a non-knot-type locking UI.

6. The method of claim 2, wherein displaying the preview comprises:
gradually changing the locking UI based on the unlocking interaction input; and
gradually displaying the execution screen corresponding to the changing of the locking UI.

7. The method of claim 2, wherein displaying the execution screen includes:
determining whether the unlock interaction is inputted until the unlock condition for the release of the locking mode is satisfied in the given user interface; and
displaying the execution screen of the application along with the release of the locking mode when the unlock interaction is inputted in a manner that satisfies the unlock condition.

8. The method of claim 2, wherein the locking UI is displayed according to a user setting.

9. The method of claim 2, wherein the displayed locking UI is randomly selected from among a plurality of locking user interfaces.

10. The method of claim 1, further comprising calling the execution screen of the application.

11. The method of claim 1, further comprising:
detecting a release of the unlock interaction input, prior to the completion of the unlock interaction input;
removing the preview of the execution screen; and
displaying a locking user.

12. A touch device comprising:
a touch sensor that receives an unlock interaction input during a locking mode;
a display that displays a locking User Interface (UI); and
a controller that determines whether the locking mode is released based on the unlock interaction input received through the locking UI, and displays an execution screen of an application via the display, when the unlock interaction input is completed.

13. The touch device of claim 12, wherein the locking UI is displayed according to a user setting.

14. The touch device of claim 12, wherein the displayed locking UI is randomly selected from among a plurality of locking user interfaces.

15. The touch device of claim 12, wherein the controller displays a preview of the execution screen of the application via the display, while the unlock interaction input is being input.

16. The touch device of claim 12, wherein the locking UI comprises:
an unlock item through which the unlock interaction input is input.

17. The touch device of claim 12, wherein the controller selectively displays an application item for the application in the locking UI.

18. The touch device of claim 12, wherein the locking user interface comprises one of:
a zipper-type locking UI;
a knot-type locking UI; and
a non-knot-type locking UI.
